(19) United States
(12) Patent Application Publication
(10) Pub. No.: US 2001/0007975 A1
(43) Pub. Date: Jul. 12, 2001

(54) Data access system

(75) Inventors: James Ronald Nyberg JR., Tampa, FL (US); Brian S. Plotkin, Brandon, FL (US); Brion Cory Lance, Riverview, FL (US); David L. Watkins, Riverview, FL (US)

Correspondence Address: Leonard Charles Suchyta, Esq., Verizon Services Group, 600 Hidden Ridge HQE03H01, Irving, TX, 75038, US

(73) Assignee: GTE Service Corporation

(21) Appl. No.: 09/796,223

(22) Filed: Feb. 28, 2001

Related U.S. Application Data
(63) Continuation of application No. 09/178,627, filed on Oct. 26, 1998.

(51) Int. Cl. G06F 17/60

(52) U.S. Cl. 705/1

(57) ABSTRACT

Systems consistent with the present invention provide a secure private network for accessing confidential law enforcement data over a public network. The system includes a server terminal located at a central facility for storing the accessed data and a plurality of client terminals. Each client terminal is preferably located in a different law enforcement agency, varying in jurisdiction on either a local, regional, national, or international level. The client terminals communicate with the server terminal over the public network. To ensure that the information is secure when it is transferred over the public network or when it is stored at the server terminal, the system uses multiple layers of security, including smart cards, data encryption, user authentication and firewalls.

### BACKGROUND OF THE INVENTION

1. Field of the Invention

The present invention relates to methods and systems for accessing law enforcement data and, more particularly, to methods and systems for securely accessing law enforcement data over a public network.

2. Description of the Related Art

Contrary to popular belief, law enforcement agencies in different jurisdictions lack computer systems for sharing information. To access the data gathered by another agency, an officer must have the information given to him or her over the phone, by mail, or in person. For many years, law enforcement agencies have been hampered by the absence of a way to efficiently share information amongst the different agencies on a regional, state, or national level. Consequently, mobile criminals have been able to avoid arrest and prosecution in many instances by keeping on the move.

An additional concern for sharing investigative information between different law enforcement agencies is the highly confidential nature of such information. If the information is not kept secure, its integrity could easily be lost when a large number of users have access to the information. For example, persons having access to the information could inadvertently modify or delete the information. Thus, there is a need for a system providing a secure network for sharing confidential law enforcement data between different law enforcement agencies.

### SUMMARY OF THE INVENTION

Systems consistent with the present invention provide a secure network for accessing confidential law enforcement data over a public network. The invention is thus able to expand the resources available to various law enforcement agencies by pooling together the data of each agency for sharing on a secure network system.

To achieve these and other advantages, a data access system consistent with the present invention comprises a server terminal for storing law enforcement data relating to criminal investigative activity. The server terminal further includes a database server for storing the law enforcement data and a first encryption device for encrypting the law enforcement data stored in the database server according to an encryption algorithm. The server terminal further includes a firewall for preventing unauthorized users from accessing the law enforcement data stored in the database server. A public network connection device, coupled to the server terminal, transfers the encrypted law enforcement data from the server terminal to a remote location over a public network.

A further aspect of the invention includes a memory for storing law enforcement data for access from a remote location over a public network. The memory includes an incident file for storing law enforcement data on a particular criminal incident. The incident file includes incident location data reflecting a location where the particular criminal incident occurred and incident type data reflecting a type of criminal incident. Also included is a map file reflecting maps of a geographical area capable of being subdivided to illustrate an area corresponding to the incident location data of the incident file.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a block diagram of a data access system (DAS) 100 consistent with the present invention;

FIG. 2 is a flow diagram of a method for transferring data between a server terminal 110 and a client terminal 120 of DAS 100; and

FIGS. 3A to 3T are diagrams of graphical user interface of DAS 100 displayed by client terminal 120 to a user.

### DETAILED DESCRIPTION

Systems consistent with the present invention provide a secure network for accessing confidential law enforcement data using a public network. The system includes a server terminal located at a central facility for storing the accessed data and a plurality of client terminals. Each client terminal is preferably located in a different law enforcement agency, varying in jurisdiction on either a local, regional, national, or international level, and covering a diverse multi-jurisdictional area. The client terminals communicate with the server terminal over the public network. To ensure the security of information transferred over the public network or stored at the server terminal, the system uses a multiple of layers of security, including smart cards, user authorization levels, data encryption and firewalls.

The server terminal further includes a plurality of server units for performing a respective service offered by the system. The system then integrates these varying services into a single, seamless application that provides a host of tools for law enforcement agencies. Tools or services offered by the server units include storing various types of law enforcement data, such as incident reports, suspect lists, most wanted lists, or maps of different jurisdictions. The server units also provide the ability to search the stored information or to communicate with other client terminals over secure data lines. In this way, the system expands the resources available to various law enforcement agencies by pooling together the data of each agency for common access over a secure network system.

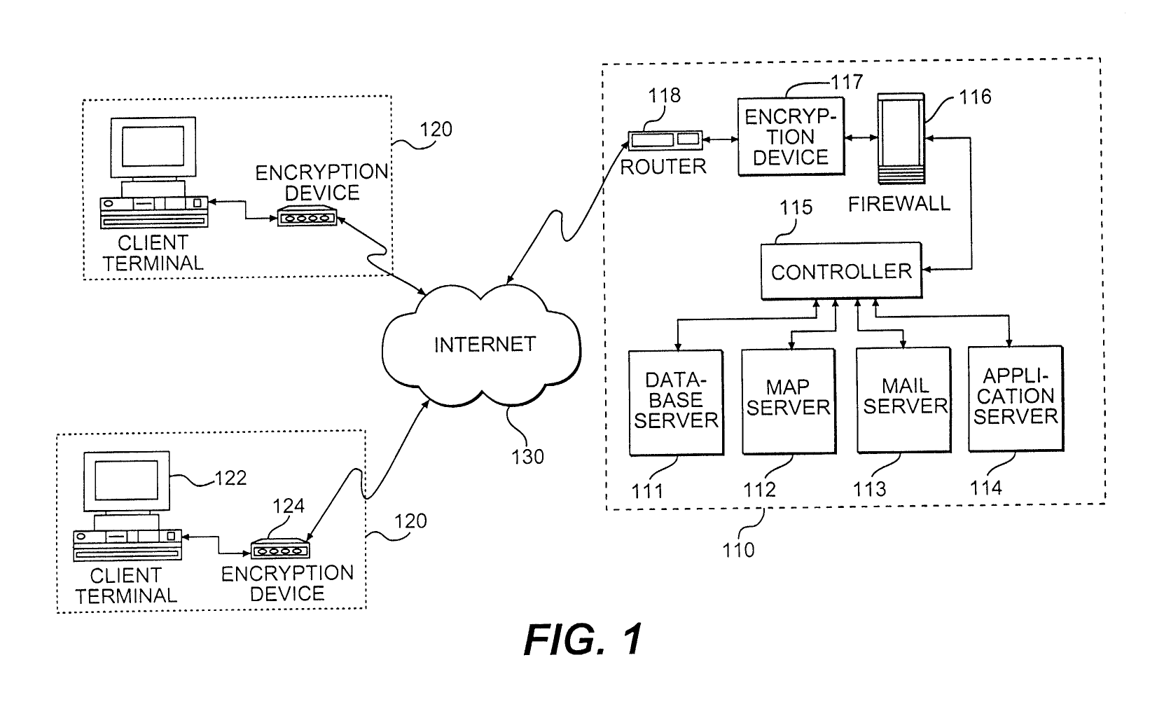

Embodiments of the present invention will now be described with reference to the accompanying drawings. FIG. 1 shows a block diagram of a data access system (DAS) 100 consistent with the present invention. As shown in FIG. 1, DAS 100 includes a server terminal 110, a plurality of client terminals 120, and a public network 130 for connecting terminals 110 and 120 together. While public network 130 is preferably the Internet, other types of public networks may be used to implement DAS 100. In addition, while FIG. 1 shows only two client terminals 120, any number of client terminals 120 may be used as part of DAS 100.

Server terminal 110 is located at a central location and further includes a plurality of servers 111 to 114, a controller 115, a firewall 116, an encryption device 117, and a router 118. Servers 111 to 114 provide the system services of DAS 100 offered to client terminals 120. Although the servers shown are intended to be exemplary only, the servers preferably include: a database server 111 for providing access to stored law enforcement data; a map server 112 for providing access to a bank of vector and raster map data defining maps for an entire region, such as the United States; a mail server 113 for providing a secure e-mail service between users; and an application server 114 for integrating all of the services offered by DAS 100 into a single application. Though each of servers 111 to 114 preferably includes a separate memory for storing data, servers 111 to 114 may share a common memory for storing data. Finally, as described below, each of the servers 111 to 114 includes a search engine for searching the stored data.

Controller 115 determines which server 111 to 114 to access based upon a request received from client terminal 120. Firewall 116 is located between controller 115 and public network 130, and prevents access to servers 111 to 114 by an unauthorized party on public network 130. While firewall 116 may be implemented using any standard firewall known to those skilled in the art, server terminal 10 preferably uses a CyberGuard™ firewall to provide a high level of security. Though FIG. 1 shows only one firewall 116, server terminal 110 may include more than one firewall to increase the level of protection of servers 111 to 114.

Encryption device 117 encrypts data sent from server terminal 110 and decrypts data received from client terminals 120. In this way, only encrypted data is transferred between server terminal 110 and client terminals 120 over public network 130. Although a variety of encryption techniques may be used, DAS 100 preferably encrypts data using Data Encryption Standard (DES) encryption, known to those skilled in the art. Router 118 then transfers the encrypted data between server terminal 110 and client terminals 120 over public network 130.

Client terminals 120 are preferably located at a law enforcement agency for use by authorized law enforcement officers. As shown in FIG. 1, client terminal 120 further includes a personal computer (PC) 122 and an encryption device 124. PC 122 is preferably a standard PC having a network browser, such as Netscape. PC 122 runs on a standard operating system, such as Windows 95™ or Windows NT™ operating system.

Encryption device 124 further includes an encryption unit and a smart card reader for reading smart cards issued to each authorized user (both not shown). Encryption device 124 is preferably part of a public network connection device, such as a modem or an ISDN, to public network 130. Though the encryption unit and the smart card reader may be separate units, encryption device 124 preferably includes both in one unit, as is commercially available from Information Resources Engineering, Inc. As described above, data transferred between server terminal 110 and client terminals 120 on public network 130 are encrypted using DES encryption.

DAS 100 assigns a specific Internet Protocol (IP) address to each encryption device 124, with each IP address corresponding to a particular user authorization level. Controller 115 can then restrict access to servers 111 to 114 based upon the IP address sent from encryption device 124. Controller 115 generates an object defining a session identifier which is required to transact operations with server terminal 110 after log on, the generated object herein referred to as a “cookie.” Controller 115 stores the cookie in PC 122 after the user has logged onto DAS 100. The cookie and the IP address are then compared to an authorization table stored in controller 115 listing all registered users and their corresponding encryption devices 124. If both the cookie and the IP address match an entry in the authorization table, then the user's request is passed to the appropriate server of servers 111 to 114. In this way, DAS 100 controls access to the services of DAS 100 consistent with each user's authorization level.

The use of a smart card provides a further level of security to DAS 100. As known in the art, a smart card comprises a personal plastic card powered by an integrated circuit chip. To gain access to DAS 100, a user must insert the smart card into the smart card reader and then enter a personal identification number (PIN) to authenticate the user. Encryption device 124 will not operate, and, therefore, client terminal 120 will not have access to server terminal 110, unless the user inserts a valid card and enters a valid identification number.

Data transferred across public network 130 by either server terminal 110 or client terminal 120 is transferred using Internet Protocol (IP) address hiding known to those skilled in the art. The IP address hiding increases the security of the transferred data by hiding the source and destination IP addresses before one of terminals 110 or 120 transmits the data. The terminal receiving the data recovers the hidden addresses and then sends the data to the intended address.

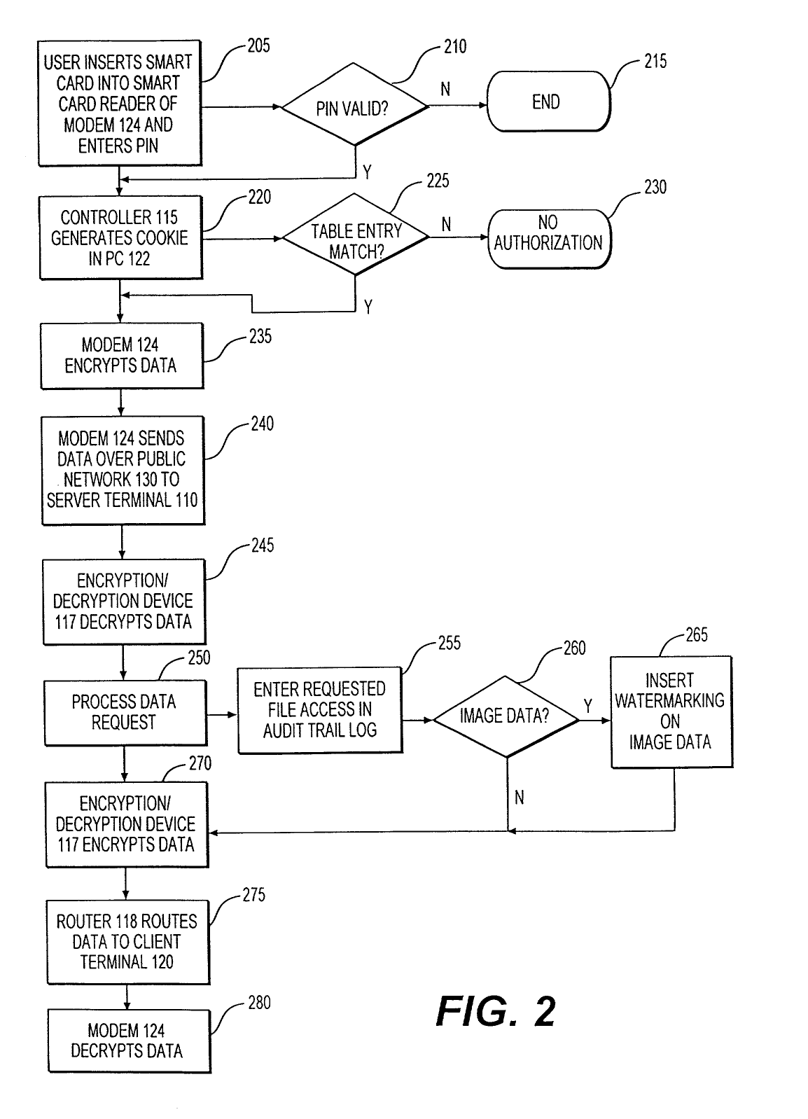

The operation of DAS 100 will now be described with reference to FIG. 2. FIG. 2 shows a flow diagram of a method for transferring data between server terminal 110 and one of client terminals 120. As shown in FIG. 2, a user must first log onto DAS 100 by inserting a smart card into the smart card reader of encryption device 124 and entering a PIN (step 205). DAS 100 then determines whether the PIN is valid (step 210). If the PIN is not valid, DAS 100 determines that the user is not authorized and-ceases all communications between client terminal 120 and server terminal 110 (step 215). If, on the other hand, the user does enter a valid PIN, then the user is allowed access to server terminal 110.

Controller 115 then generates a cookie for PC 122 and compares the generated cookie and the IP address assigned to encryption device 124 to the authorization table stored in controller 115 (steps 220 and 225). If the cookie and the IP address do not match an entry of the authorization table, then the user is informed that an unauthorized request has been made (step 230). Processing then returns to step 225 until the user makes a new request. If, on the other hand, the cookie and the IP address match an entry in the authorization table, then the user's request is passed to the appropriate server of servers 111 to 114.

The user may request to transfer data to or from server terminal 110. When transferring data to server terminal 110, the encryption unit of device 124 will first encrypt all data sent to server terminal 110 during the communication session (step 235). Encryption device 124 then sends the encrypted data over public network 130 to server terminal 110 (step 240).

At the server end, router 118 receives the encrypted data and passes the data to encryption/decryption device 117 to decrypt the received data (step 245). Firewall 116 receives the decrypted data and only passes data to controller 115 that comes from a valid client terminal 120. Based upon the received data, controller 115 then accesses one of servers 111 to 114 to process the user's request (step 250).

Each request by the user invokes one of a variety of services offered by DAS 100 and performed by one of servers 111 to 114. For example, users may request to store, modify or delete data stored in database server 111. Database server 111 stores various types of law enforcement data, such as incident reports, suspect lists, and most wanted lists. To store the data, users enter data into a blank form displayed on PC 122. The displayed form preferably mimics the paper forms currently being used by various law enforcement agencies, and includes drop down select fields for data having known entry values. Database server 111 then downloads this data into a database (not shown) for later access by client terminals 120.

To ensure the integrity of data stored in servers 111 to 114, controller 115 maintains a list of security levels for individual users of DAS 100 authorizing modification or deletion of the stored data. In addition, CDS 100 also maintains an audit trail for each file accessed by users (step 255). In particular, when a user stores, modifies, or deletes any data, database server 111 updates an audit trail log that identifies the action taken by the user, the data the user accessed, and the date and time the user accessed the data.

Database server 111 also uses digital watermarks to place a stamp of authenticity on stored documents. When a user stores image data (e.g., a photograph, crime scene illustration, etc.), a digital watermark is placed on a selected portion of the image (steps 260 and 265). In particular, server 111 computes a watermark value based upon the color of each pixel in the image to be stored. The watermark value is then appended to the inherent “white space” of the image. When the image is later retrieved, its authenticity can be verified by removing the watermark value from the image and recomputing the watermark value for that image. If the two watermark values match, then the user is notified that the image is authentic.

Map server 112 provides access to a bank of vector and raster map data defining maps for an entire region, such as the United States. Users can also request map server 112 to display maps superimposed with the locations of particular crimes. This is accomplished through the use of a geocoding process by which the addresses entered into database server 111 using the blank form described above, are mapped to their corresponding latitude and longitude coordinates. In this way, users can graphically view and analyze crime patterns for any particular area by viewing the location of a crime or criminal's residence on a map.

Servers 111 to 114 also include a search engine for searching the stored data. Although a number of searching techniques may be used, the search engine preferably performs text searches, semantic searches, fuzzy searches, and facial searches. The normal text search looks for matches in a selected field, while semantic searching looks for different word variations of the entered search query. Fuzzy text search searches all of the servers 111 to 114, to look for matches based on associated or related items, such as synonyms or recognized terms. Facial search looks for matches between a selected facial image and those stored in database server 111.

Other server units also provide the ability to communicate with other client terminals 120 over the secure data lines using public network 130. For example, chat server 113 provides users-with a secure environment in which users can electronically communicate with one another. Mail server 114 provides a secure e-mail service between users of client terminals 120.

After server terminal 110 processes the user's request (steps 250 to 265), any data sent to client terminal 120 is then passed to encryption/decryption device 117 for encryption (step 270). Router 118 then routes the encrypted data to the appropriate client terminal 120 (step 275). Once the data is received by client terminal 120, encryption device 124 decrypts the received data and passes the decrypted data to PC 122 where it can be displayed to the user (step 280).

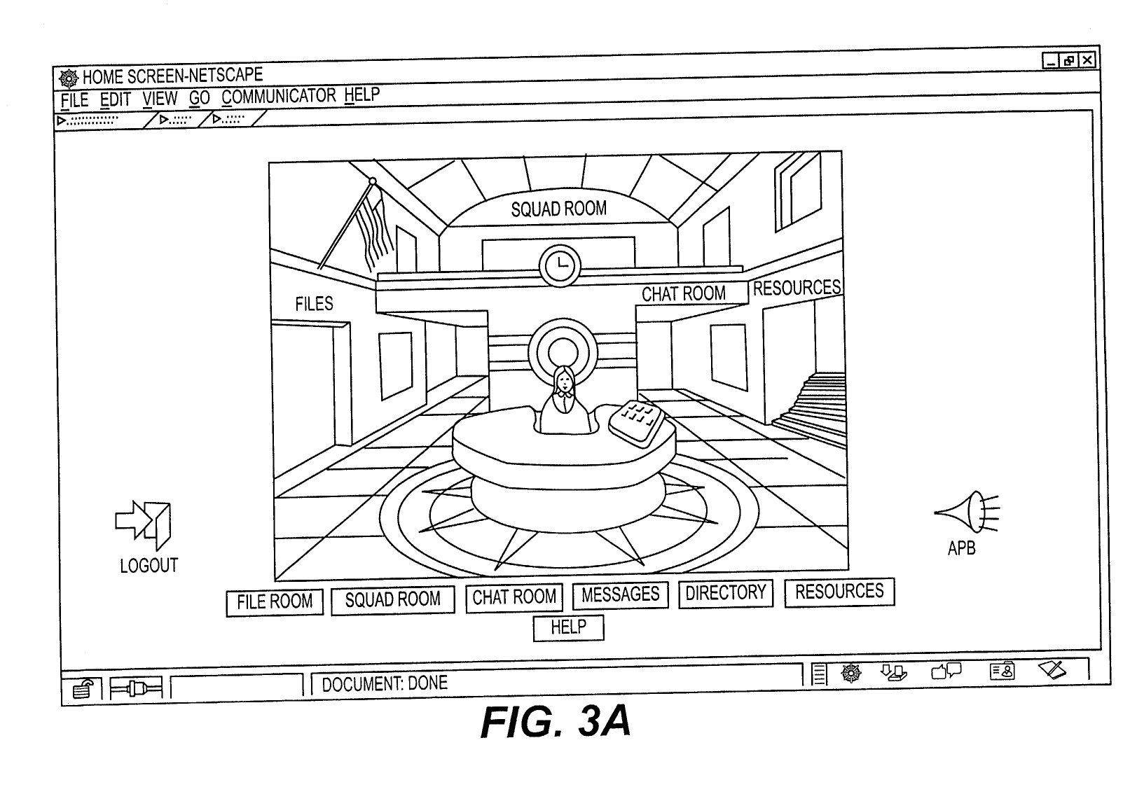

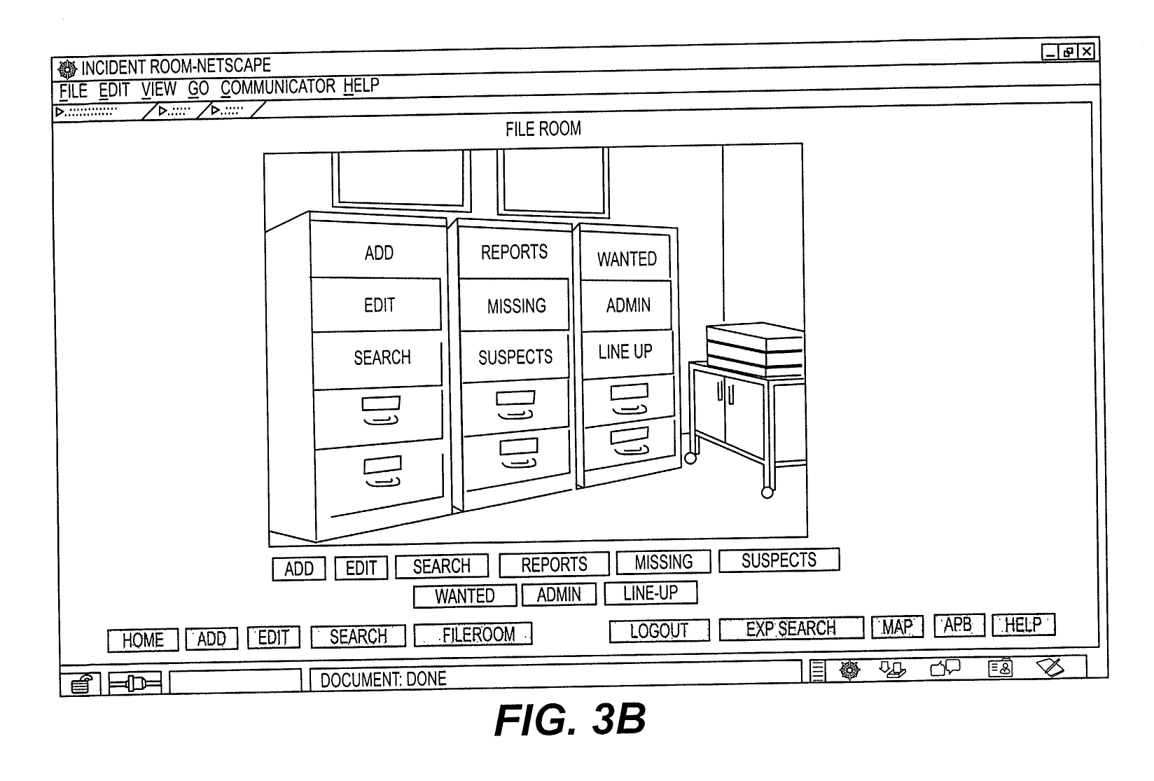

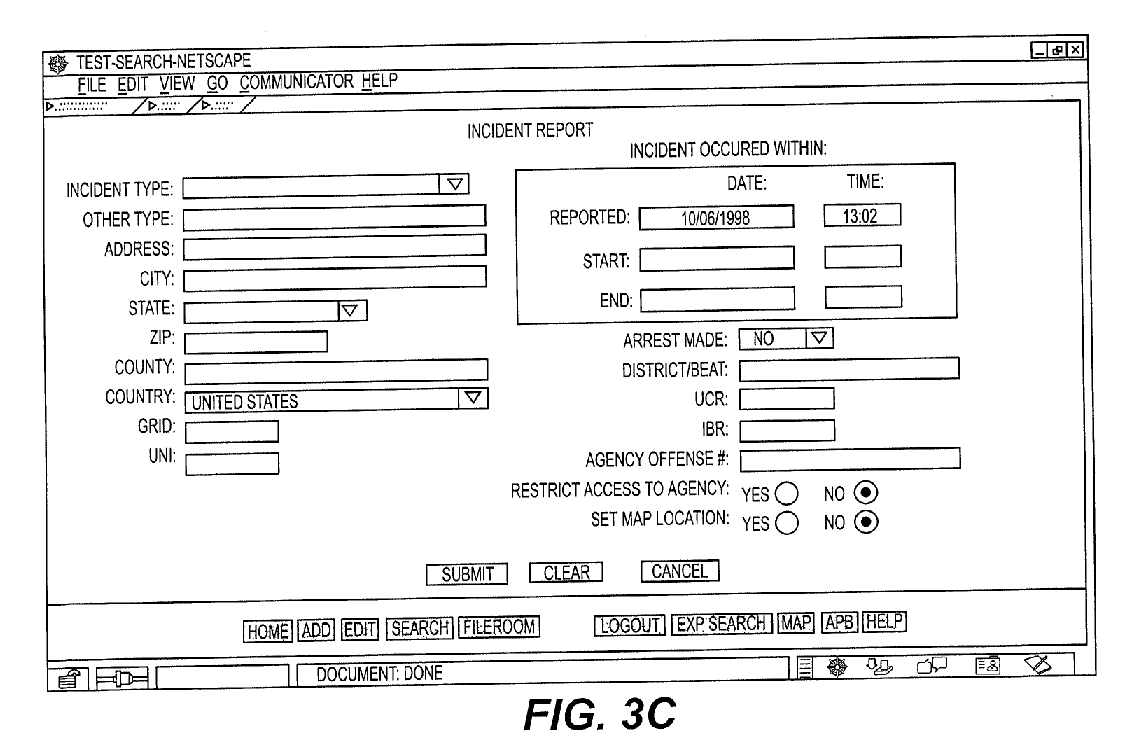

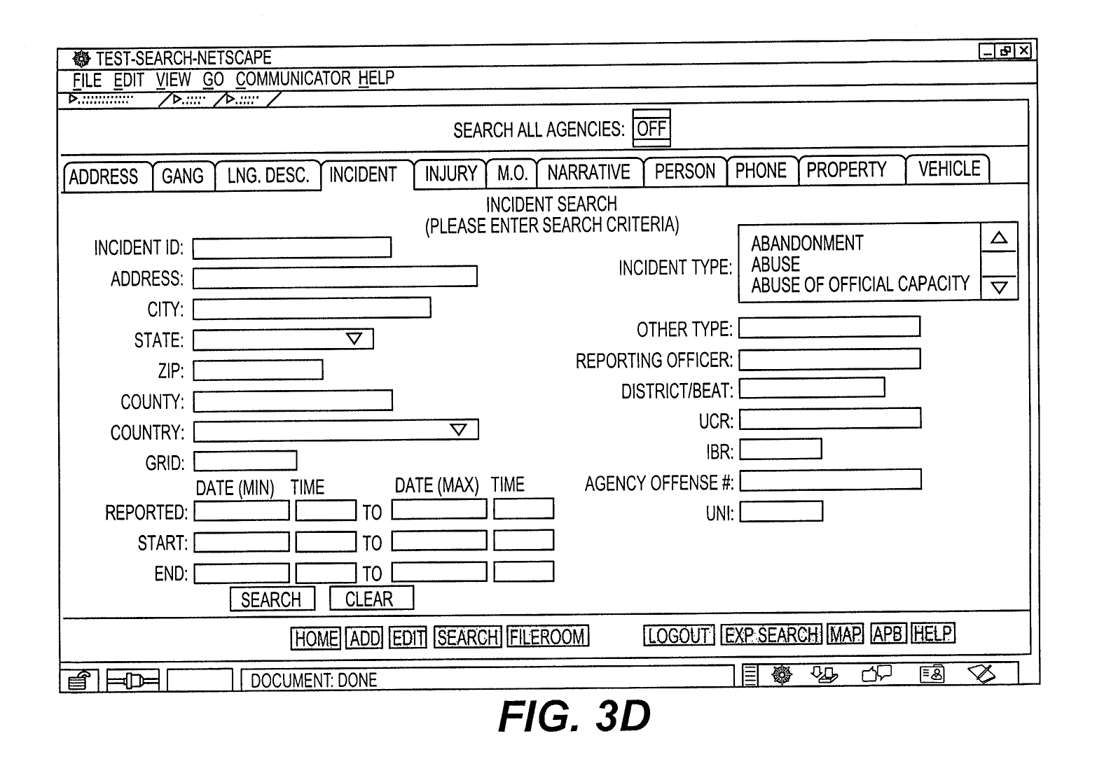

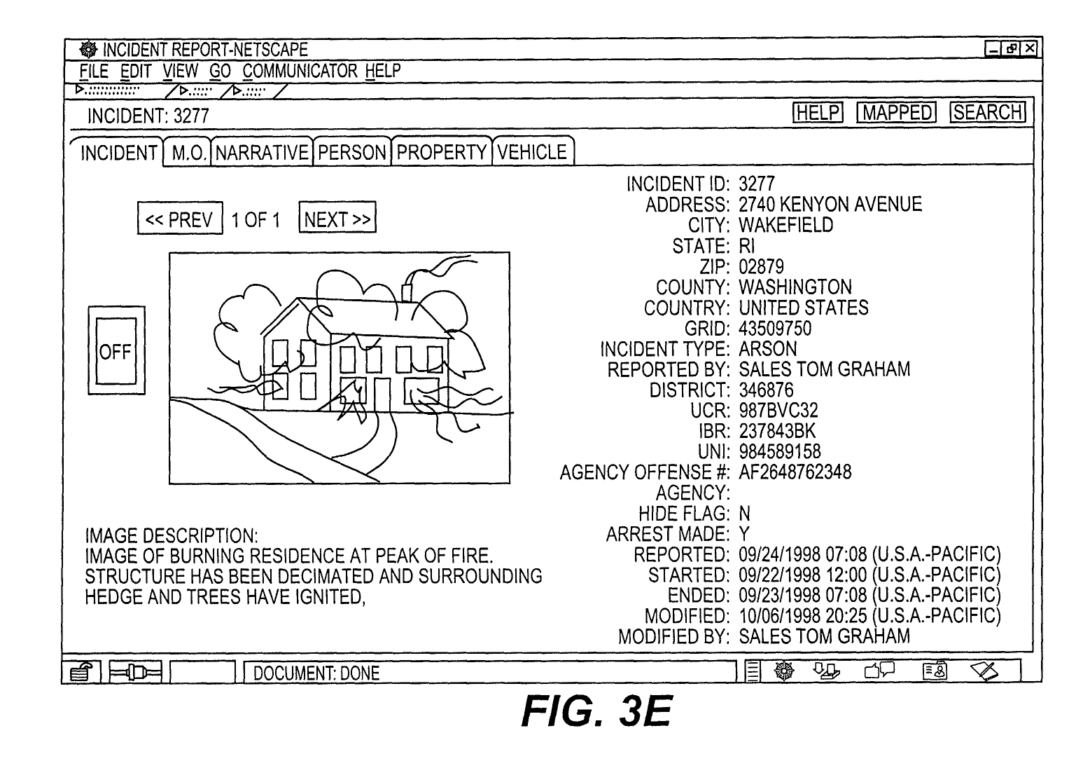

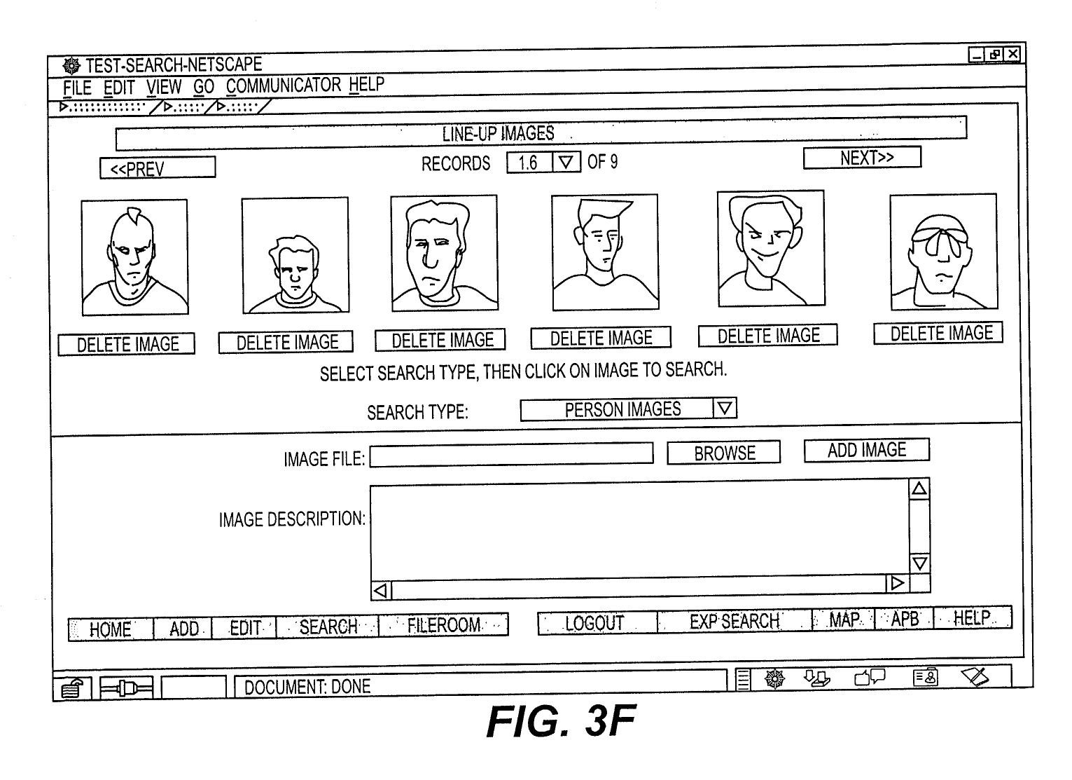

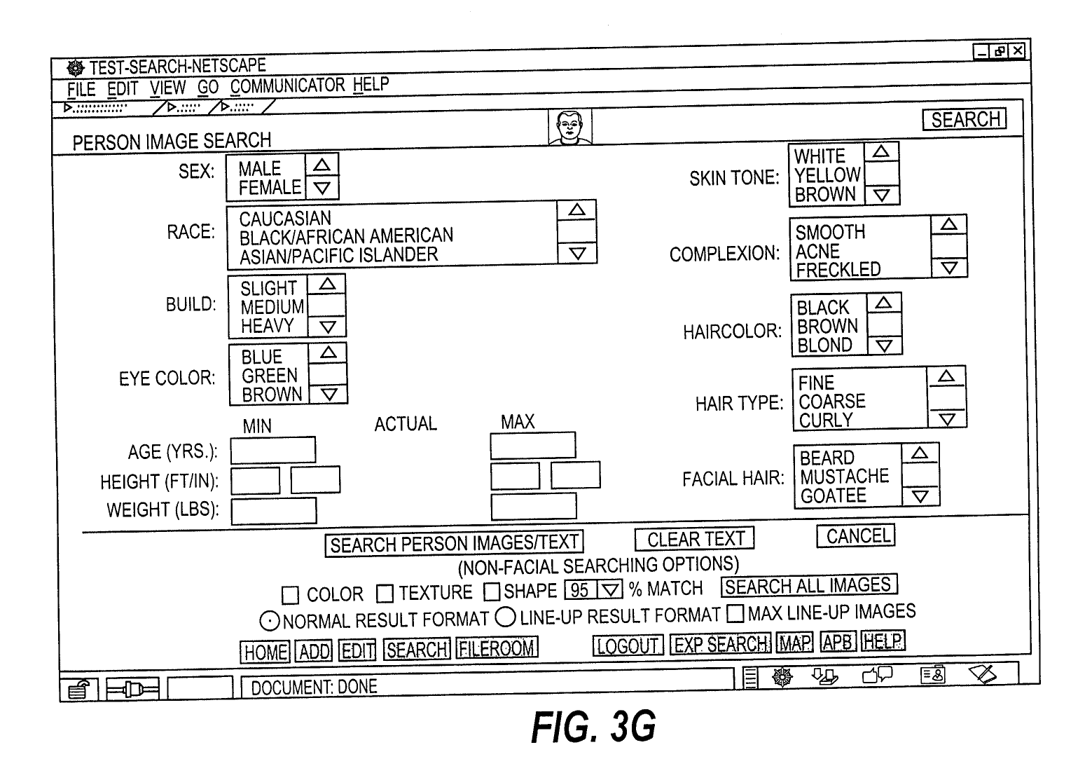

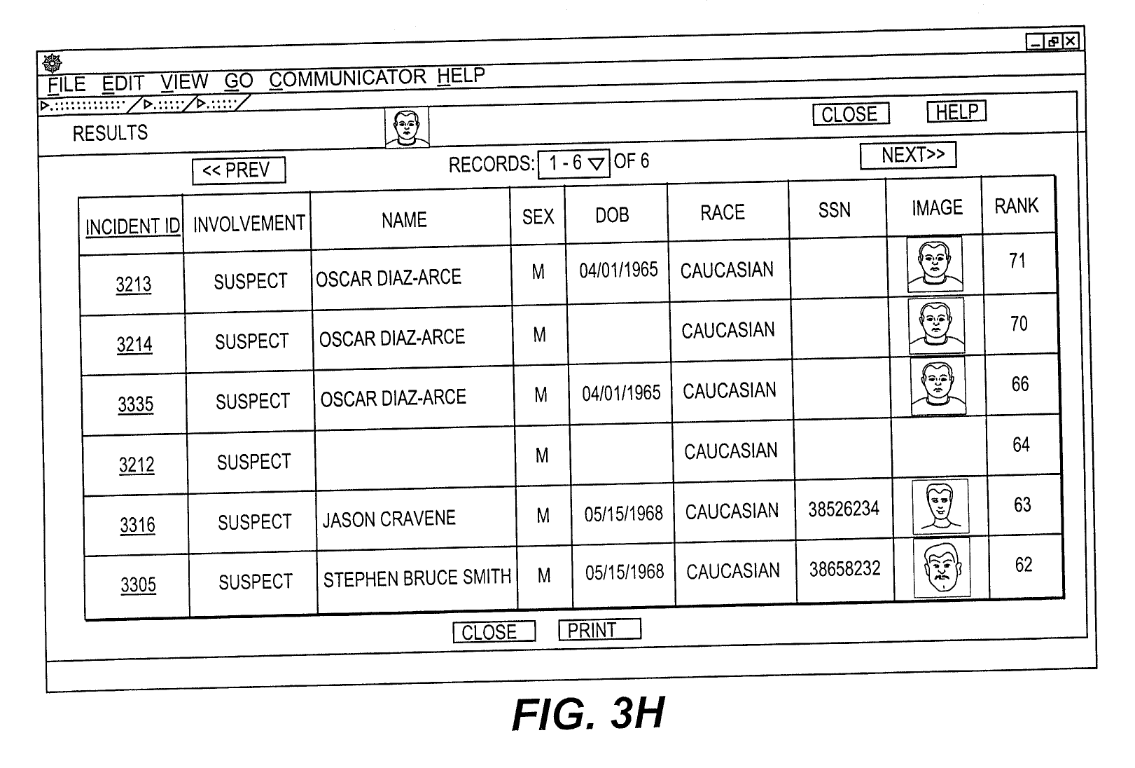

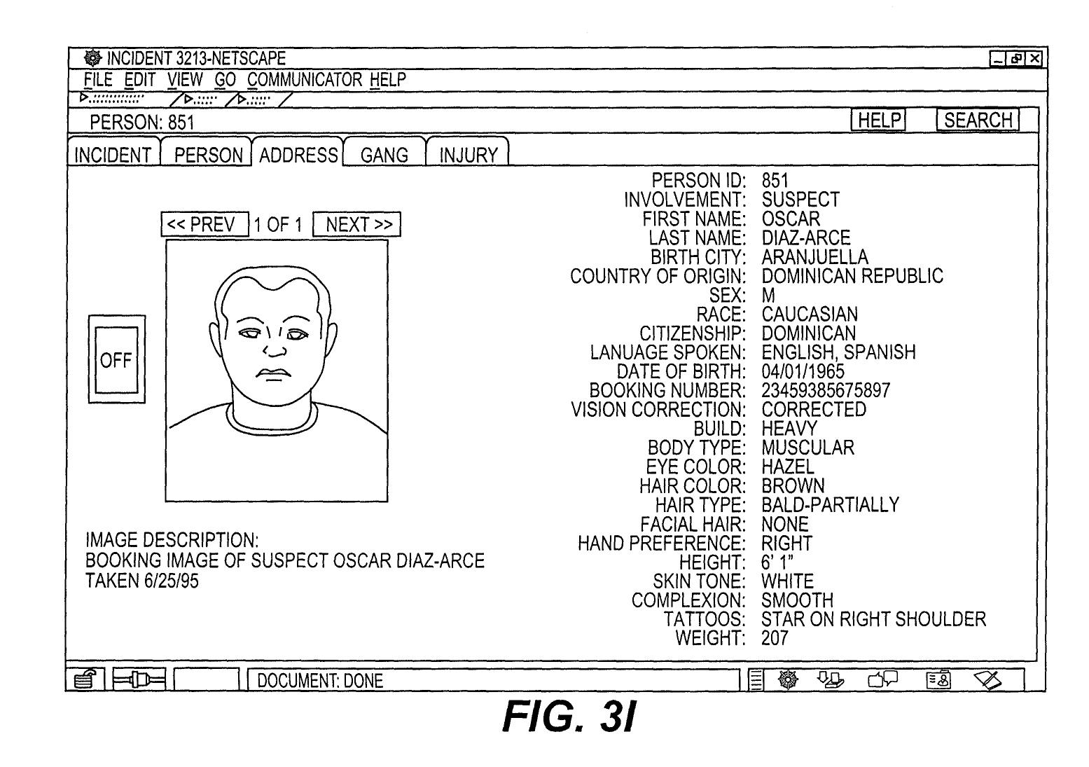

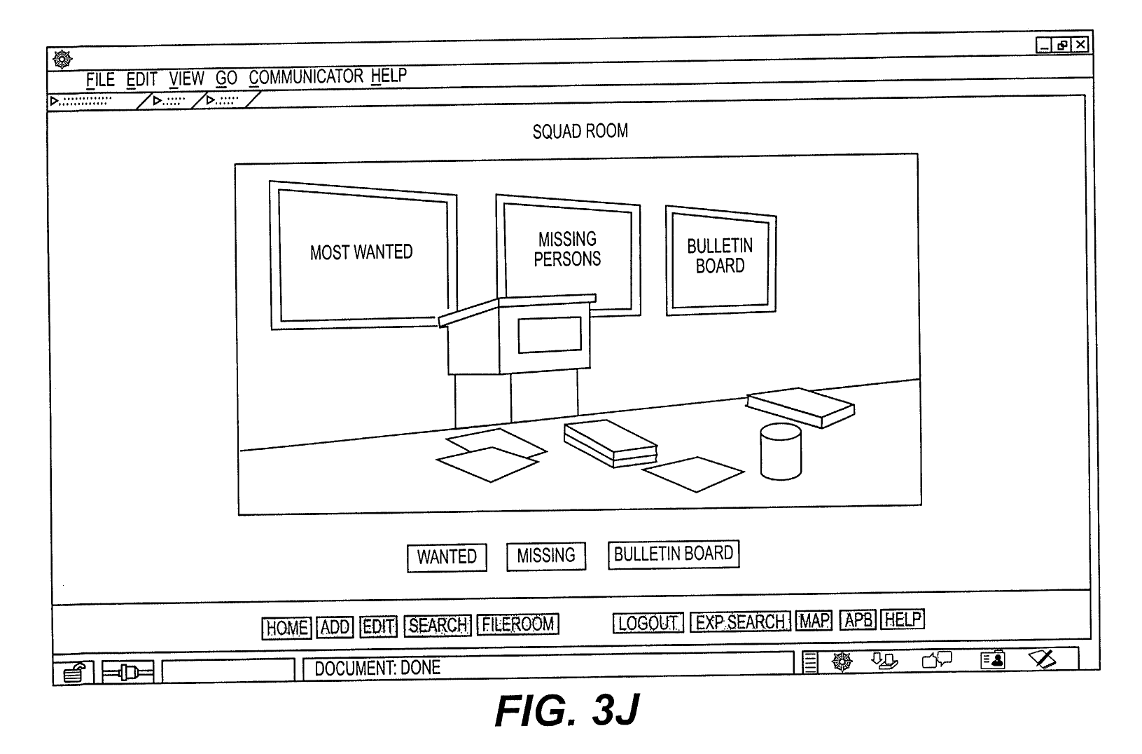

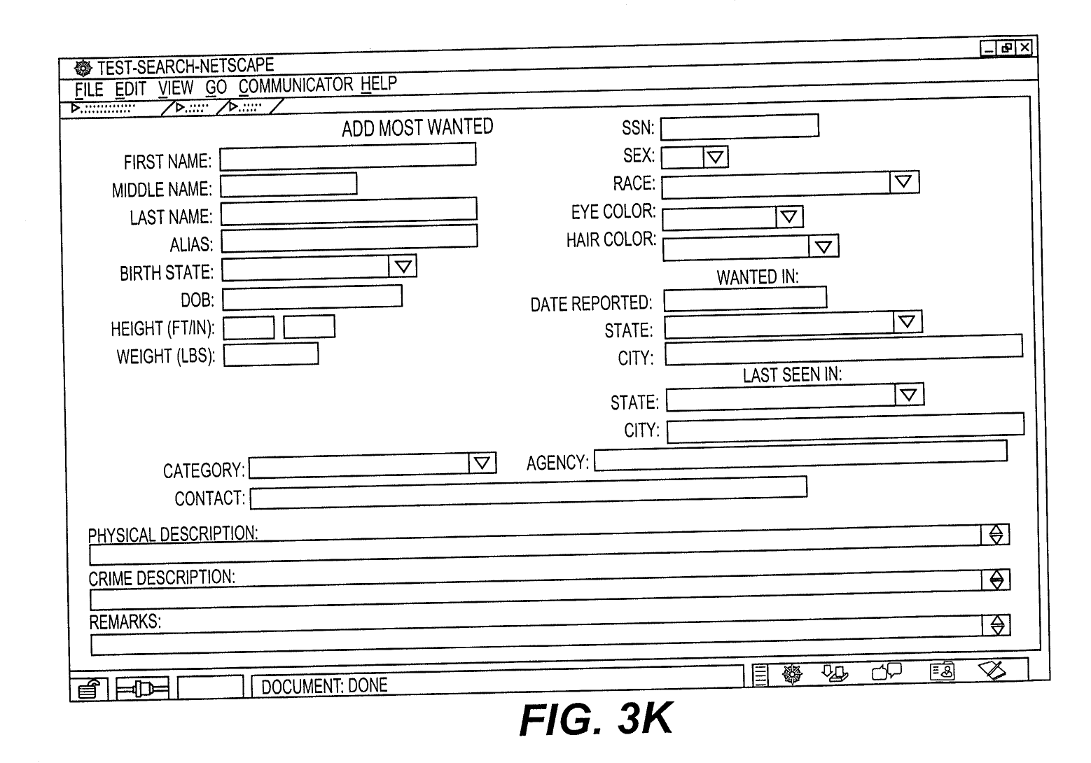

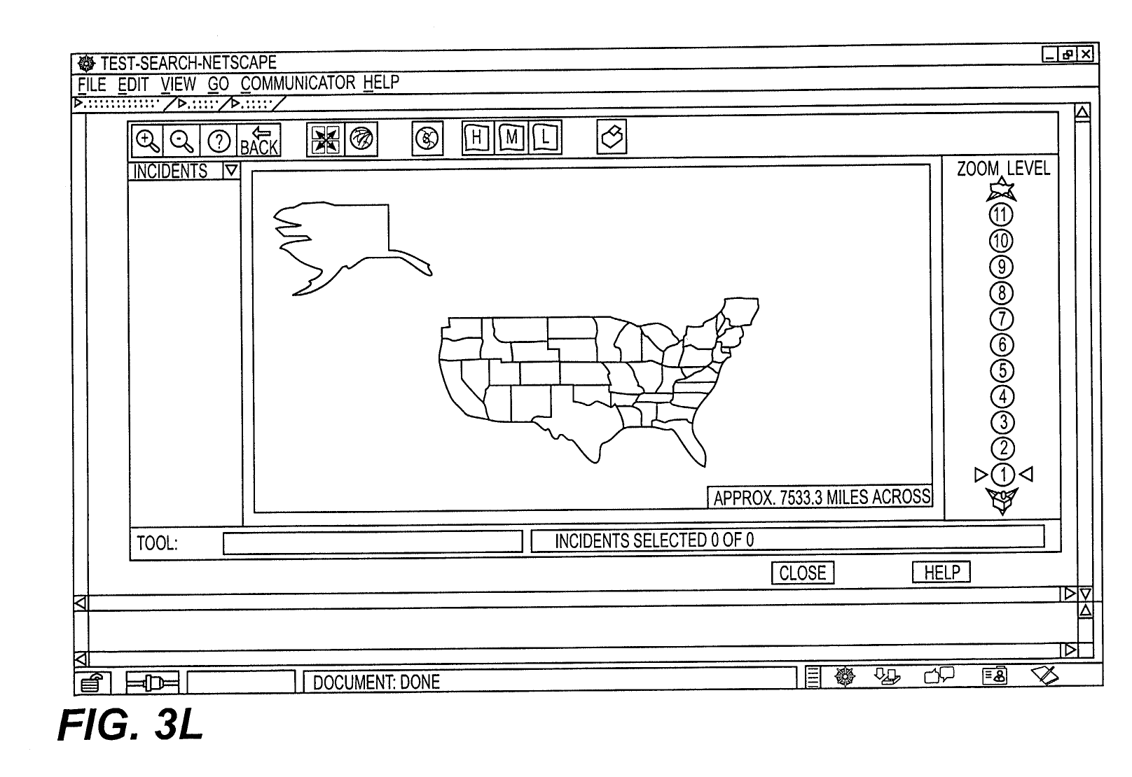

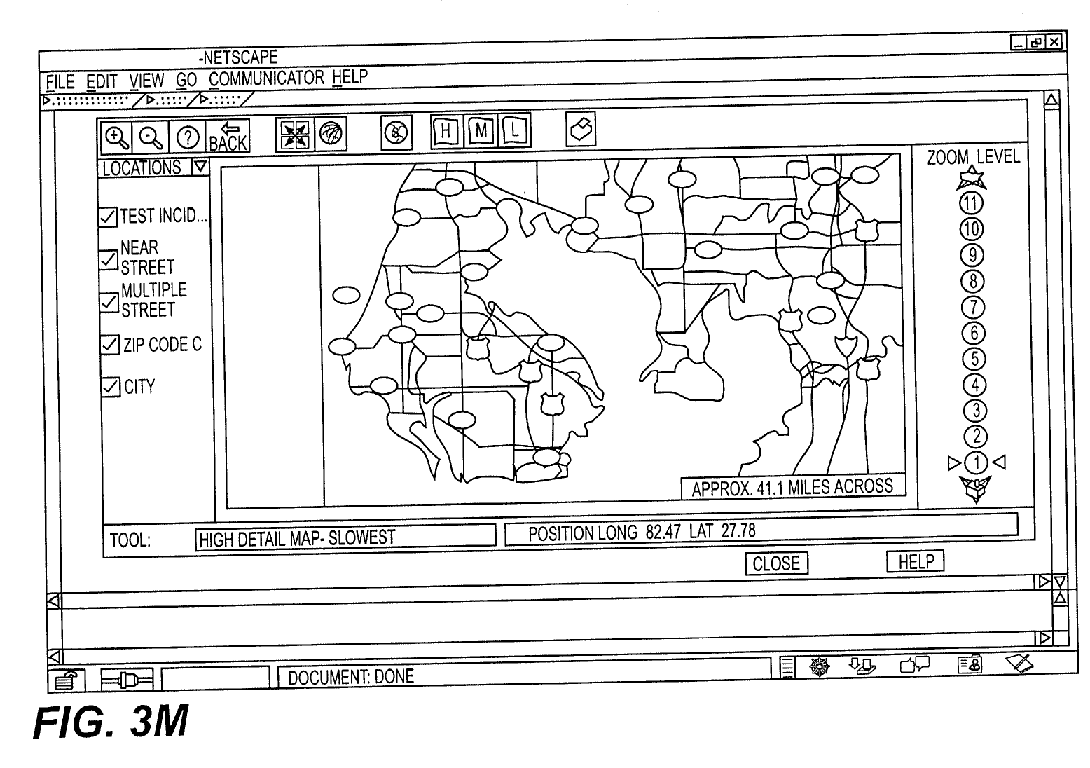

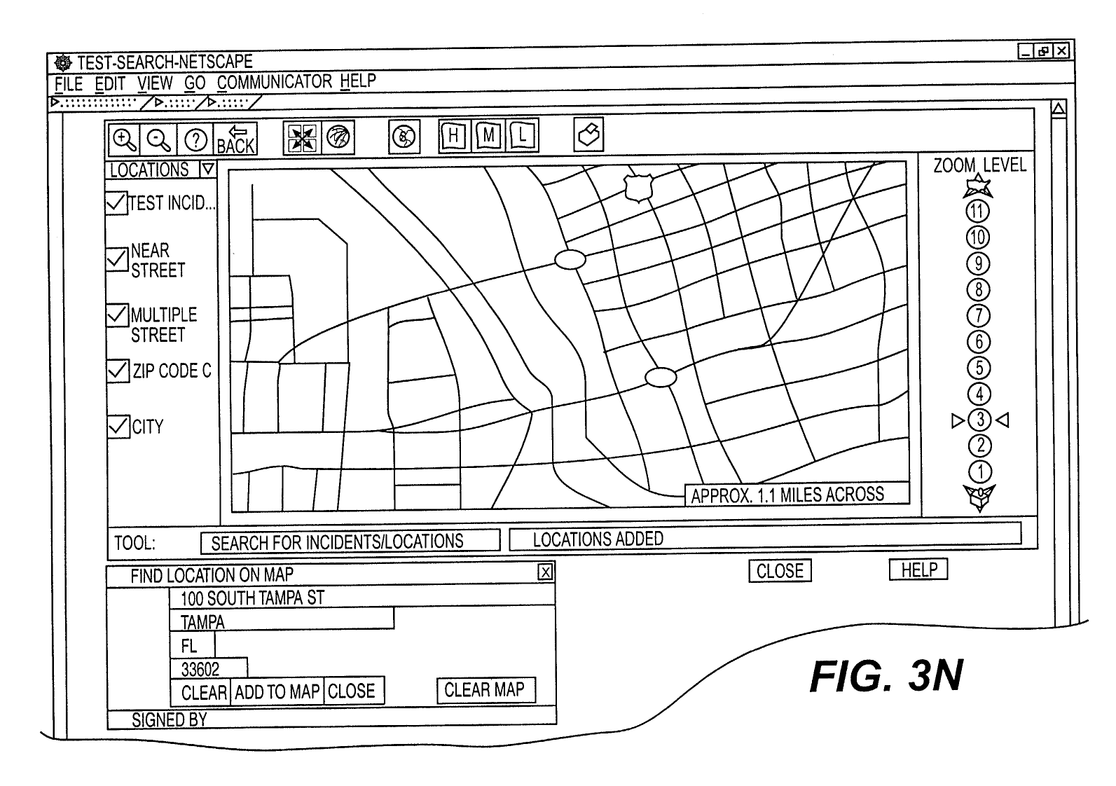

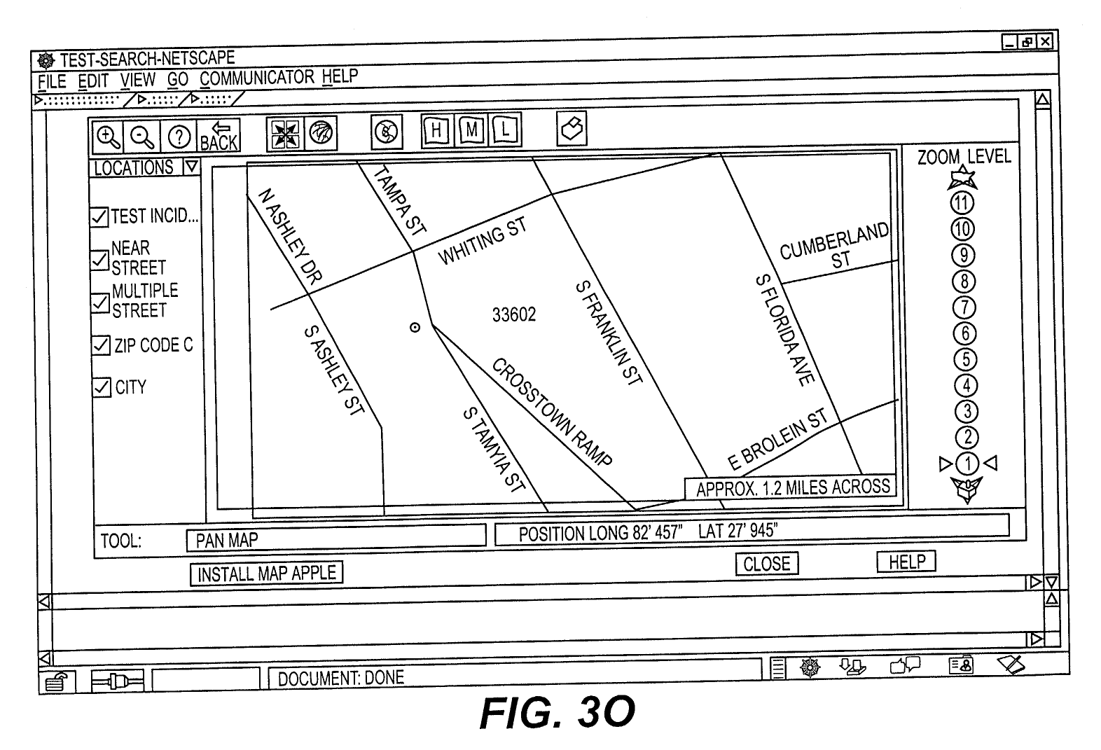

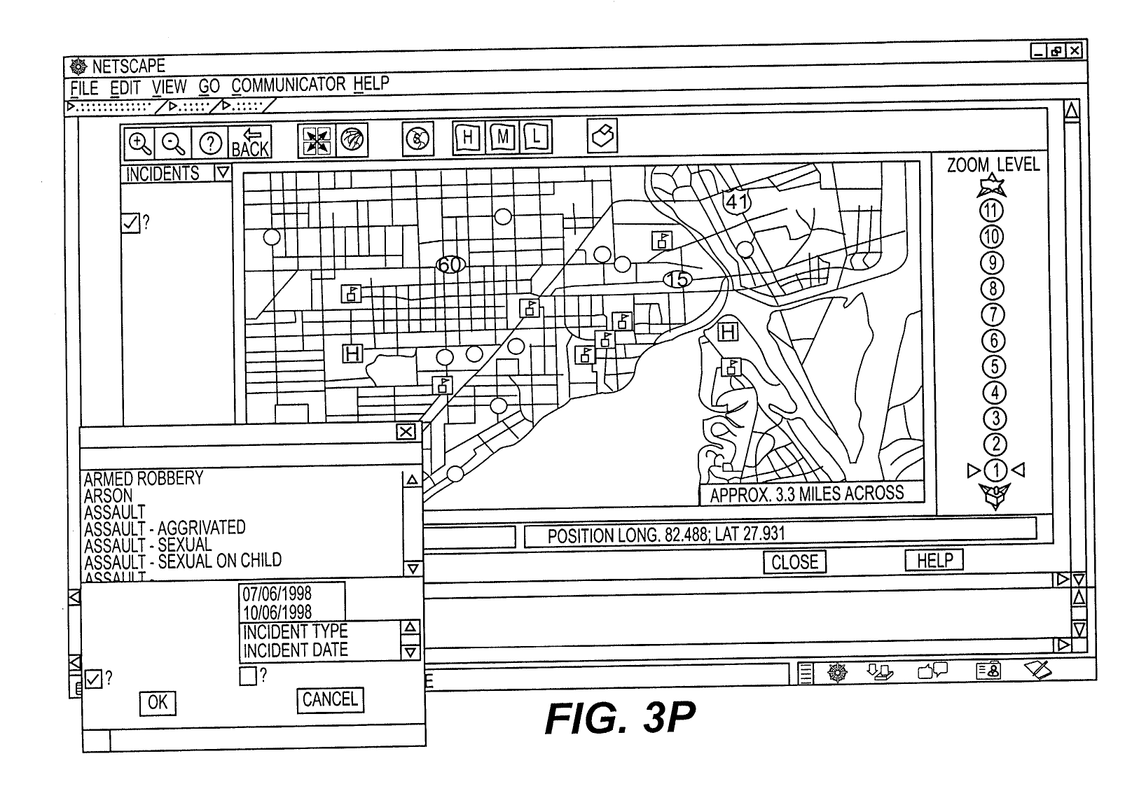

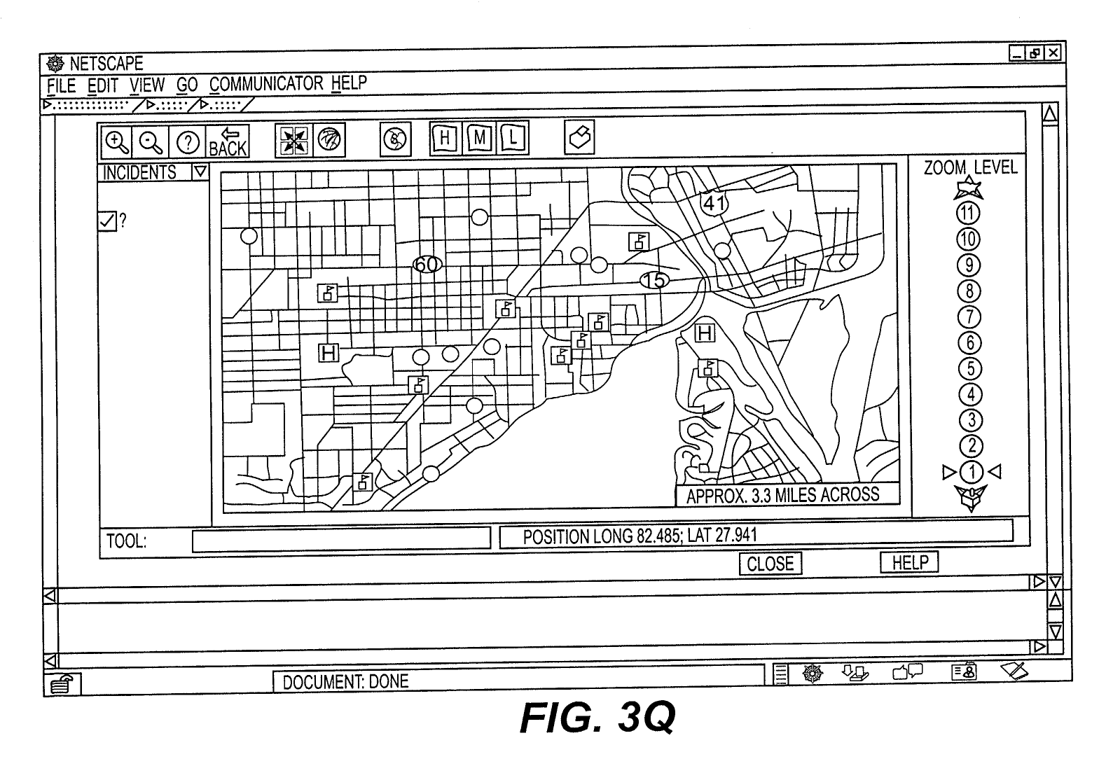

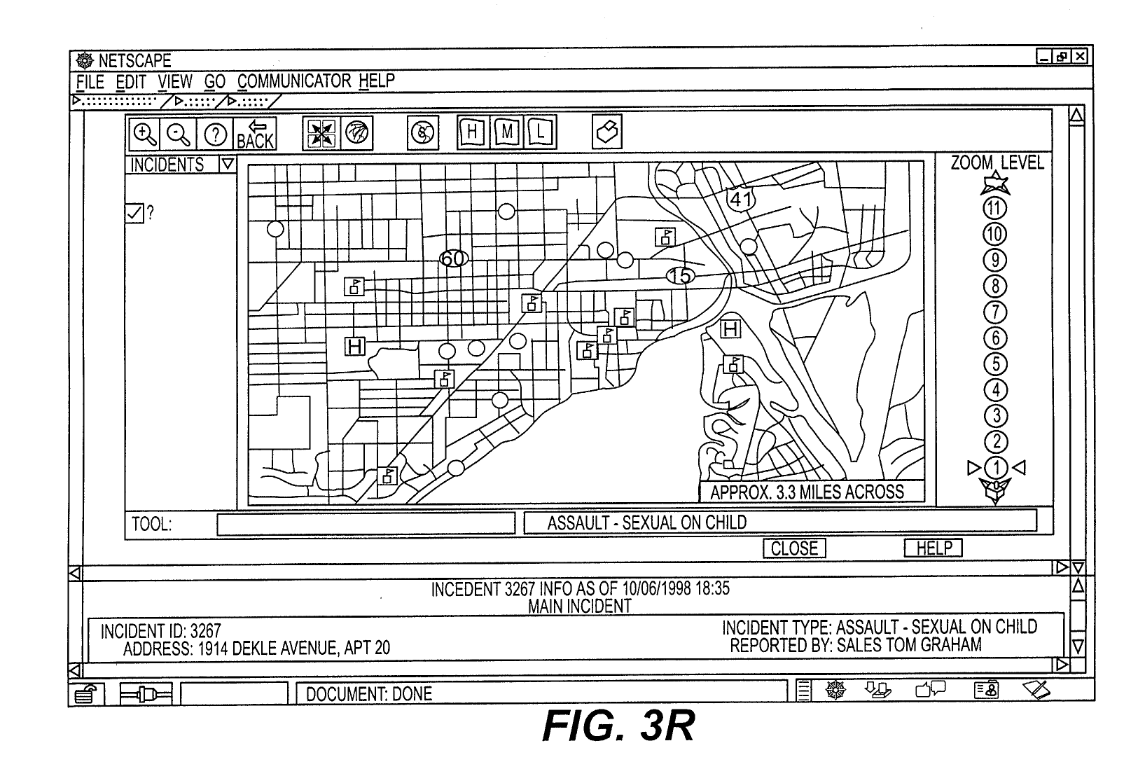

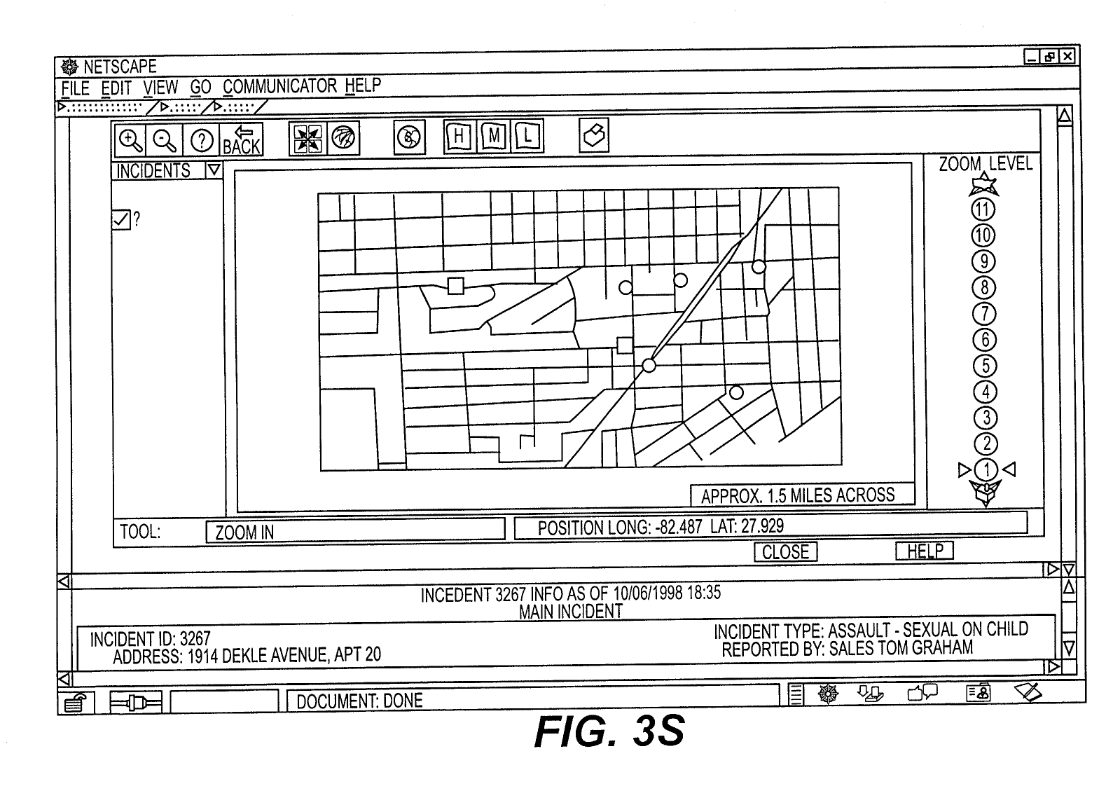

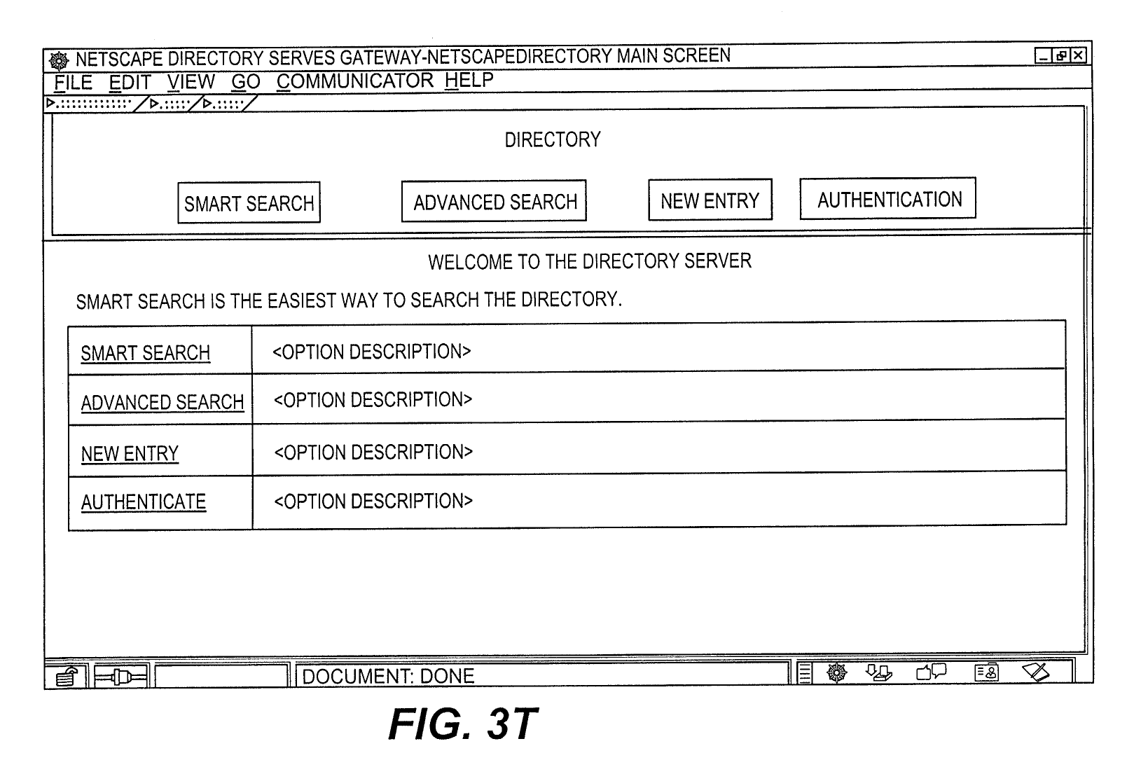

As described above, application server 114 integrates each of the services and tools of DAS 100 into a single user application. FIG. 3A is a graphical user interface (GUI) screen of the home page of the application software. As described above, a user can enter or search for data regarding a particular criminal incident. For example, FIG. 3B is a GUI screen through which a user can access various data entry screens for entering or searching data stored in database server 111. FIG. 3C is a GUI screen for entering data on a particular incident for storage in database server 111, while FIG. 3D is a GUI screen for searching for stored incidents. FIG. 3E is a GUI screen that displays the results of a particular incident search.

DAS 100 also provides access to images stored in database server 111. FIG. 3F, for example, is a GUI screen for viewing images of suspects or convicted criminals stored in database server 111, while FIG. 3G is a GUI screen for searching for stored images. FIG. 3H is a GUI screen that displays the results of a particular image search. FIG. 3I is a GUI screen showing identifying information for a particular suspect or criminal selected from the image search results.

DAS 100 also provides access to data posted by any one of the law enforcement agencies registered with DAS 100. FIG. 3J is a GUI screen through which a user can access the posted data. FIG. 3K is a GUI screen for entering data on a most wanted person for view by all users of DAS 100.

As described above, DAS also provides access to maps stored in map server 112. FIGS. 3L to 3O, for example, are GUI screens for displaying maps of varying detail on an area selected by a user. FIGS. 3P and 3Q are GUI screens for displaying maps superimposed with landmark and/or criminal data. FIGS. 3R and 3S are GUI screens for displaying information on a particular map-displayed incident selected by a user. Finally, FIG. 3T is a GUI screen through which a user can access a user directory listing information about all registered users of DAS 100.

Therefore, systems consistent with the present invention provide a secure private network for accessing confidential law enforcement data over a public network. The invention is thus able to expand the resources available to various law enforcement agencies by pooling together the data of each agency for sharing on a secure network system. It will be apparent to those skilled in the art that various modifications and variations can be made to the system and method of the present invention without departing from the spirit or scope of the invention. Additionally, although aspects of the present invention are described as being stored in memory, one skilled in the art will appreciate that these aspects can also be stored on other types of computer-readable media, such as secondary storage devices, like hard disks, floppy disks, or CD-ROM, a carrier wave from the Internet or other propagation medium, or other forms of RAM or ROM. The present invention covers the modifications and variations of this invention provided they come within the scope of the appended claims and their equivalents.

What is claimed is:

1. A system for securely accessing law enforcement data, the system comprising:
a server terminal for storing law enforcement data corresponding to criminal investigative activity, the server terminal including:
a database server for storing the law enforcement data,
a server encryption device for encrypting the law enforcement data stored in the database server according to an encryption algorithm, and
a firewall for preventing unauthorized users from accessing the law enforcement data stored in the database server;
a public network coupled to the server terminal for transferring the encrypted law enforcement data from the server terminal; and
a plurality of client terminals, each located at a remote location and coupled to the server terminal via the public network, for receiving the encrypted law enforcement data from the server terminal, each client terminal including:
a public network connection device for receiving the encrypted law enforcement data sent from the server terminal over the public network,
a client encryption device for decrypting the received encrypted law enforcement data,
a smart card reader for reading a smart card issued to a user of the system, wherein the smart card activates the public network connection device when the user enters into the smart card reader a valid personal identification number, and
a display means for displaying the decrypted law enforcement data.

2. The system of claim 1, wherein the server terminal further includes:
a map server for providing access to a bank of vector and raster map data defining geographical maps.

3. The system of claim 1, wherein the server terminal further includes:
a mail server for providing a secure e-mail service between users of each client terminal.

4. The system of claim 1, wherein the server terminal further includes:
a search engine for searching the law enforcement data stored in the database server.

5. The system of claim 1, wherein the public network is the Internet.

6. A method for securely accessing law enforcement data, the method comprising the steps of:
storing law enforcement data corresponding to criminal investigative activity in a database server;
encrypting the law enforcement data stored in the database server according to an encryption algorithm;
preventing unauthorized users from accessing the law enforcement data stored in the database server through the use of a firewall;
transferring the encrypted law enforcement data from the server terminal over a public network;
receiving the encrypted law enforcement data from the server terminal at one of a plurality of client terminals, wherein each client terminal is located at a remote location and coupled to the server terminal via the public network;
decrypting the encrypted law enforcement data received by the client terminal;
reading a smart card issued to a user of the system, wherein the smart card activates the client terminal when the user enters into the smart card reader a valid personal identification number; and
displaying the decrypted law enforcement data at the client terminal.

7. The method of claim 6, wherein the law enforcement data further includes vector and raster map data defining geographical maps.

8. The method of claim 6, wherein the method further includes the step of:
searching for particular law enforcement data stored in the database server using a search engine.

9. The method of claim 6, wherein the transferring step further includes the substep of:
transferring the encrypted law enforcement data from the server terminal over the Internet.

10. A system for securely accessing law enforcement data, the system comprising:
a server terminal for storing law enforcement data corresponding to criminal investigative activity, the server terminal including:
a database server for storing the law enforcement data,
a first encryption device for encrypting the law enforcement data stored in the database server according to an encryption algorithm, and
a firewall for preventing unauthorized users from accessing the law enforcement data stored in the database server; and
a network connection device, coupled to the server terminal, for transferring encrypted law enforcement data from the server terminal to a remote location over a public network.

11. The system of claim 10, wherein the server terminal further includes:
a map server for providing access to a bank of vector and raster map data defining geographical maps.

12. The system of claim 10, wherein the server terminal further includes:
a search engine for searching the law enforcement data stored in the database server.

13. The system of claim 10, wherein the public network is the Internet.

14. A method for securely accessing law enforcement data, the method comprising the steps of:
storing law enforcement data corresponding to criminal investigative activity in a database server;
encrypting the law enforcement data stored in the database server according to an encryption algorithm;
preventing unauthorized users from accessing the law enforcement data stored in the database server through the use of a firewall; and
transferring encrypted law enforcement data from the server terminal to a remote location over a public network.

15. The method of claim 14, wherein the law enforcement data further includes vector and raster map data defining geographical maps.

16. The method of claim 14, wherein the method further includes the step of:
searching for particular law enforcement data stored in the database server using a search engine.

17. The method of claim 14, wherein the transferring step further includes the substep of:
transferring the encrypted law enforcement data from the server terminal over the Internet.

18. A memory for storing law enforcement data for access from a remote location over a public network, the memory comprising:
an incident file for storing law enforcement data on a particular criminal incident, including incident location data reflecting a location where the particular criminal incident occurred and incident type data reflecting a type of criminal incident; and
a map film reflecting maps of a geographical area capable of being subdivided to illustrate an area corresponding to the incident location data of the incident file.

19. The memory of claim 18, further including an invokable browser object for superimposing on the subdivided map an indicia corresponding to the particular criminal incident stored in the incident file.

20. The memory of claim 19, wherein the indicia superimposed on the subdivided map by the invokable browser object corresponds to the incident type data of the particular criminal incident.

21. The memory of claim 18, further including a suspect file for storing law enforcement data on at least one criminal suspect involved with the particular criminal incident.
